(19) United States
(12) Patent Application Publication
(10) Pub. No.: US 2026/0157445 A1
(43) Pub. Date: Jun. 11, 2026

(54) AEROSOL GENERATING DEVICE INCLUDING DISPLAY WINDOW

(71) Applicant: KT&G CORPORATION, Daejeon (KR)

(72) Inventors: Dong Sung KIM, Seoul (KR); Youngbum KWON, Yongin-si (KR); Yong Hwan KIM, Anyang-si (KR); Hwikyeong AN, Seoul (KR)

(73) Assignee: KT&G CORPORATION, Daejeon (KR)

(21) Appl. No.: 19/179,182

(22) Filed: Apr. 15, 2025

(30) Foreign Application Priority Data
May 9, 2024 (KR) 10-2024-0061323

(51) Int. Cl. A24F 40/60; A24F 40/40

(52) U.S. Cl. CPC A24F 40/60; A24F 40/40

(57) ABSTRACT

An aerosol generating device includes a casing including a base surface and a side surface connected to the base surface, in which the side surface includes a first recess, a display window disposed in the first recess and including a first rib, and a cover coupled to the casing and including a first cover base disposed on the base surface, a second cover base connected to one side of the first cover base and at least partially overlapping the first rib, and a second rib configured to engage with the casing.

### CROSS-REFERENCE TO RELATED APPLICATION

This application claims priority from Korean Patent Application No. 10-2024-0061323 filed on May 9, 2024, in the Korean Intellectual Property Office, the entire disclosure of which is incorporated herein by reference for all purposes.

### BACKGROUND

### 1. Field of the Invention

One or more embodiments relate to an aerosol generating device, and for example, to an aerosol generating device including a display window.

### 2. Description of the Related Art

Techniques for introducing airflows into an aerosol generating article are being developed to provide atomization performance. For example, aerosol generating devices that generate an aerosol from an aerosol generating article in a non-burning manner are being developed. The above description is information the inventor(s) acquired during the course of conceiving the present disclosure, or already possessed at the time, and is not necessarily art publicly known before the present application was filed.

### SUMMARY

Embodiments provide an aerosol generating device including a display window. Embodiments provide an aerosol generating device with an smooth exterior.

According to an aspect, there is provided an aerosol generating device including a casing including a base surface and a side surface connected to the base surface, wherein the side surface includes a first recess, a display window disposed in the first recess and including a first rib, and a cover coupled to the casing and including a first cover base disposed on the base surface, a second cover base connected to one side of the first cover base and at least partially overlapping the first rib, and a second rib configured to engage with the casing.

The aerosol generating device may further include a button disposed in the first recess and configured to be pressed when the display window is pressed.

The side surface may further include a button hole disposed in the first recess, and the button may be disposed in the button hole.

While the display window is pressed, a portion of the window display close to the second cover base may be configured to be moved in a direction from the display window toward the first recess, and while the display window is not pressed, an outer surface of the display window may be substantially coplanar with an outer surface of the second cover base.

The casing may further include a first groove where the first rib is disposed.

The cover may further include a third rib spaced apart from the second rib, and the second rib and the third rib may protrude from the second cover base toward inside of the casing.

The casing may further include a second groove where the second rib is disposed.

The second groove may be connected to the first groove, and a depth of the second groove may be greater than a depth of the first groove.

The display window may further include a display window inner surface facing the side surface, a display window outer surface opposite to the display window inner surface, and a display window end portion close to the second cover base among end portions of the display window, the first rib may protrude in a direction from the display window end portion toward the second cover base on the display window inner surface, and the first rib may extend from an entire portion of the display window end portion.

The cover may further include a hook, and the hook may include a first hook base extending from the second cover base toward inside of the casing, and a second hook base extending from an end portion of the first hook base in a direction intersecting the extending direction of the first hook base.

The casing may further include a hook receiver that engages with the hook, and the hook receiver may include a slit where the first hook base is disposed.

The hook receiver may further include a receiver opening where the second hook base is disposed.

The hook receiver may further include an inclined surface.

The second rib may include an inclined surface on an edge of the second rib.

The base surface may include a second recess where the first cover base is disposed.

Additional aspects of embodiments will be set forth in part in the description which follows and, in part, will be apparent from the description, or may be learned by practice of the disclosure.

According to an embodiment, the components of the aerosol generating device may be fixed to each other. According to an embodiment, the display window may be moved only within a set range. The effects of the aerosol generating device including the display window according to an embodiment may not be limited to the above-mentioned effects, and other unmentioned effects may be clearly understood from the following description by one of ordinary skill in the art.

### BRIEF DESCRIPTION OF THE DRAWINGS

These and/or other aspects, features, and advantages of the invention will become apparent and more readily appreciated from the following description of embodiments, taken in conjunction with the accompanying drawings of which:

FIG. 1 illustrates an aerosol generating device according to an embodiment of the present disclosure;

FIG. 2 illustrates an aerosol generating device according to another embodiment of the present disclosure;

FIG. 3 is a front perspective view of an aerosol generating device according to an embodiment of the present disclosure;

FIG. 4 is a rear perspective view of an aerosol generating device according to an embodiment of the present disclosure;

FIG. 5 is a rear perspective view of an internal structure of an aerosol generating device including a thermal insulator and a printed circuit board (PCB), according to an embodiment of the present disclosure;

FIG. 6 is a rear perspective view of an internal structure of an aerosol generating device including a battery according to an embodiment of the present disclosure;

FIG. 7 is an exploded rear perspective view of an internal structure according to an embodiment of the present disclosure;

FIG. 8 is a cross-sectional view of an aerosol generating device according to an embodiment of the present disclosure;

FIG. 9 is a perspective view of an aerosol generating device including a susceptor and a temperature sensor, according to an embodiment of the present disclosure;

FIG. 10 is an exploded perspective view of a thermal insulator according to an embodiment of the present disclosure;

FIG. 11 is a cross-sectional view of a thermal insulator according to an embodiment of the present disclosure;

FIG. 12 is a partially enlarged view of the thermal insulator of FIG. 11, according to an embodiment;

FIG. 13 is a block diagram of an aerosol generating device according to an embodiment of the present disclosure;

FIG. 14 is a perspective view of an aerosol generating device according to an embodiment;

FIG. 15 is an exploded perspective view of an aerosol generating device showing a casing, a display window, and a cover according to an embodiment;

FIG. 16 is a perspective view of a casing according to an embodiment;

FIG. 17 is a perspective view of a casing and a button according to an embodiment;

FIG. 18 is a perspective view of a cover according to an embodiment;

FIG. 19 is a perspective view of a display window and a cover according to an embodiment;

FIG. 20 is a cross-sectional view of an aerosol generating device according to an embodiment; and

FIG. 21 is a cross-sectional view of an aerosol generating device according to an embodiment.

### DETAILED DESCRIPTION

Description will now be given in detail according to embodiments set forth herein with reference to the accompanying drawings. The same or equivalent components may be denoted by the same reference numerals, and description thereof will not be repeated.

Suffixes such as “module” and “unit” used for components in the following description are assigned or interchangeably used to facilitate description of the specification and do not have any special meanings or functions.

Further, in the description of embodiments set forth herein, a detailed description of well-known related arts will be omitted when it is deemed that such description will cause ambiguous interpretation of the embodiments. Further, the accompanying drawings are merely intended for easier understanding of the embodiments set forth herein, and the technical idea of the present disclosure is not limited thereto, and the embodiments should be understood to include all changes, equivalents, and replacements within the idea and the technical scope of the disclosure.

Although terms of “first” or “second” are used to explain various components, the components are not limited to the terms. These terms are used only to distinguish one component from another component.

It should be noted that if it is described that one component is “connected,” “coupled,” or “joined” to another component, a third component may be “connected,” “coupled,” and “joined” between the first and second components, although the first component may be directly connected, coupled, or joined to the second component. On the contrary, it should be noted that if it is described that one component is “directly connected,” “directly coupled,” or “directly joined” to another component, a third component may be absent.

The singular forms “a,” “an,” and “the” are intended to include the plural forms as well, unless the context clearly indicates otherwise.

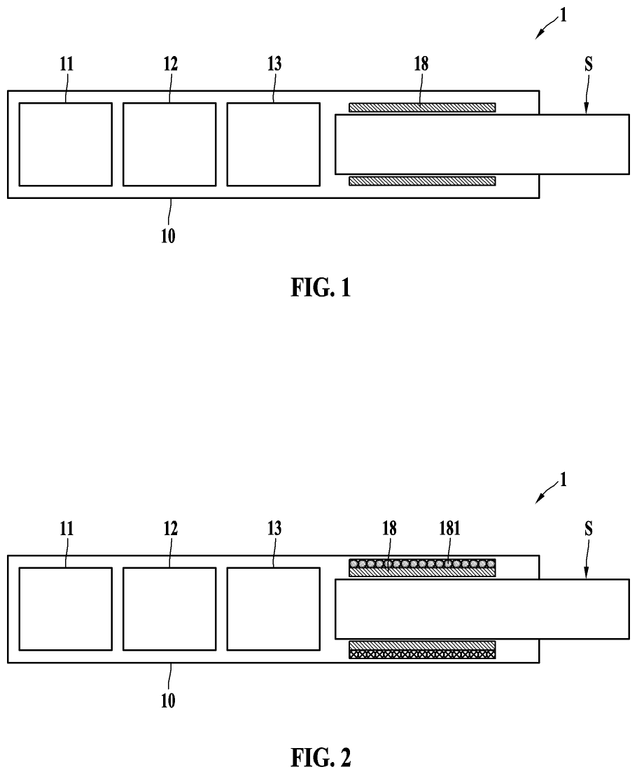

FIGS. 1 and 2 illustrate an aerosol generating device 1 according to an embodiment of the present disclosure.

Referring to FIG. 1, the aerosol generating device may include at least one of a power source 11, a controller 12, a sensor 13, and a heater 18. At least one of the power source 11, the controller 12, the sensor 13, and the heater 18 may be disposed inside a body 10 of the aerosol generating device. The body 10 may provide an upward-opening space into which a stick S, an aerosol generating article, is inserted. The upward-opening space may be referred to as an insertion space. The insertion space may be recessed by a predetermined depth toward the inside of the body 10 such that at least a portion of the stick S may be inserted into the insertion space. The depth of the insertion space may correspond to a length of an area of the stick S in which an aerosol generating material and/or a medium is included. A lower end of the stick S may be inserted into the body 10, and an upper end of the stick S may protrude outward from the body 10. A user may hold the upper end of the stick S, which is exposed to the outside, in the mouth of the user and inhale air.

The heater 18 may heat the stick S. The heater 18 may be elongated upward around a space into which the stick S is inserted. For example, the heater 18 may be in the form of a tube including a hollow therein. The heater 18 may be disposed around the insertion space. The heater 18 may be disposed to surround at least a portion of the insertion space. The heater 18 may heat the insertion space or the stick S inserted into the insertion space. The heater 18 may include an electrically resistive heater and/or an induction heater.

For example, referring to FIG. 1, the heater 18 may be a resistive heater. For example, the heater 18 may include an electrically conductive track, and the heater 18 may be heated up as a current flows through the electrically conductive track. The heater 18 may be electrically connected to the power source 11. The heater 18 may directly generate heat by receiving a current from the power source 11. As a hollow heater, the heater 18 may be disposed to surround at least a portion of the stick S inserted into the insertion space to heat an outer portion of the stick S. Alternatively, as a needle-shaped heater, a rod-shaped heater, a tubular heater, or the like, the heater 18 may be inserted into the stick S inserted into the insertion space to heat the inside of the stick S.

For example, referring to FIG. 2, the aerosol generating device may include an induction coil 181 surrounding the heater 18. The induction coil 181 may heat the heater 18. As a susceptor, the heater 18 may be heated up by a magnetic field generated by an alternating current (AC) flowing through the induction coil 181. The magnetic field may pass through the heater 18 and generate an eddy current in the heater 18. A current may generate heat in the heater 18.

In addition, the susceptor may be included inside the stick S. The susceptor inside the stick S may be heated by the magnetic field generated by the AC flowing through the induction coil 181.

The power source 11 may supply power to operate the components of the aerosol generating device. The power source 11 may be referred to as a battery. The power source 11 may supply power to at least one of the controller 12, the sensor 13, or the heater 18. When the aerosol generating device 1 includes the induction coil 181, the power source 11 may supply power to the induction coil 181.

The controller 12 may control the overall operation of the aerosol generating device. The controller may be mounted on a printed circuit board (PCB). The controller 12 may control the operation of at least one of the power source 11 or the sensor 13. The controller 12 may control the operation of the induction coil 181. The controller 12 may control the operation of a display, a motor, or the like installed in the aerosol generating device. The controller 12 may verify a state of each of the components of the aerosol generating device to determine whether the aerosol generating device is in an operable state.

The controller 12 may analyze a sensing result obtained by the sensor 13 and may control processes to be performed thereafter. For example, based on the sensing result obtained by the sensor 13, the controller 12 may control the power supplied to the heater 18 to initiate or terminate the operation of the heater 18. For example, based on the sensing result obtained by the sensor 13, the controller 12 may control the amount of power supplied to the heater 18 and a time for which the power is supplied, such that the heater 18 may be heated to a predetermined temperature or maintained at an appropriate temperature.

The sensor 13 may include at least one of a temperature sensor, a puff sensor, or an insertion detection sensor. For example, the sensor 13 may sense at least one of the temperature of the heater 18, the temperature of the power source 11, or the temperature inside and outside the body 10. For example, the sensor 13 may sense a puff of the user. For example, the sensor 13 may sense whether the stick S is inserted into the insertion space.

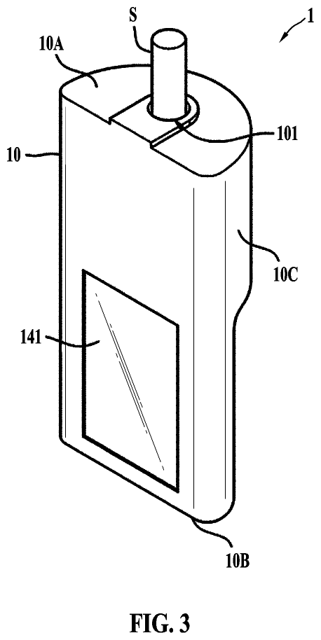

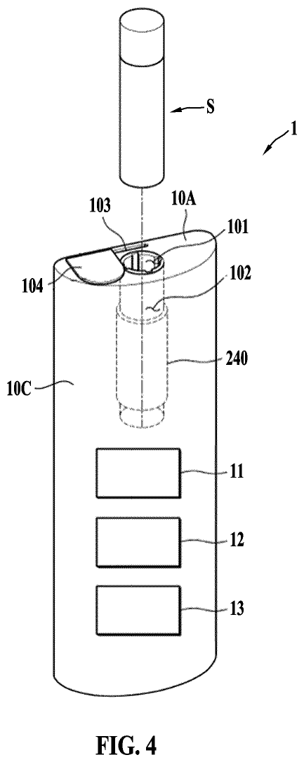

FIG. 3 is a front perspective view of an aerosol generating device according to an embodiment of the present disclosure, and FIG. 4 is a rear perspective view of an aerosol generating device according to an embodiment of the present disclosure.

Referring to FIG. 3, the aerosol generating device according to an embodiment of the present disclosure may include at least one of the power source 11, the controller 12, and the sensor 13. At least one of the power source 11, the controller 12, and the sensor 13 may be disposed inside the body 10 of the aerosol generating device 1. The description of the power source 11, the controller 12, and the sensor 13 provided with reference to FIGS. 1 and 2 may apply to the description of the features of the power source 11, the controller 12, and the sensor 13.

The body 10 may form the overall exterior of the aerosol generating device 1 and include an inner space in which the components of the aerosol generating device 1 may be disposed. Although the diagram illustrates an embodiment in which the cross-section of the body 10 has a semicircular shape overall, the shape of the body 10 is not limited thereto. The body 10 may have a cylindrical shape or a polygonal column shape overall.

The body 10 may include a first body surface 10A (e.g., a front surface of the body), a second body surface 10B (e.g., a rear surface of the body) opposite to the first body surface 10A, and at least one third body surface 10C (e.g., a side surface of the body) between the first body surface 10A and the second body surface 10B.

Referring to FIG. 4, the body 10 may have an insertion space 102 formed therein. The insertion space 102 may be formed in the upper portion of the body 10. The insertion space 102 may be opened upward. The insertion space 102 may have a vertically elongated cylindrical shape. At least a portion of the stick S may be inserted into the body 10 through an opening 101 on the upper side of the insertion space 102. The depth of the insertion space 102 may correspond to the length of an area of the stick S in which an aerosol generating material and/or a medium is included.

A heater 240 (e.g., the heater 18 of FIGS. 1 and 2) may surround at least a portion of an outer side of the insertion space 102. The heater 240 may be elongated vertically along the insertion space 102. For example, the heater 240 may be a cylindrical electrically resistive heater that surrounds at least a portion of the insertion space 102. For example, the heater 240 may include a cylindrical susceptor that surrounds at least a portion of the insertion space 102 and an induction coil that surrounds the susceptor. The heater 240 may heat the exterior of the stick S accommodated in the insertion space 102. At least an area of the stick S accommodated in the insertion space 102 may be heated by the heater 240. An aerosol may be generated as a result of the mixture of a vaporized particle generated by the heating of the stick S and air entering the inner space of the body 10 through the opening 101.

A display 141 may be disposed on one side of the body 10. At least a partial area of the display 141 may be exposed to the outside of the body 10.

The display 141 may provide a variety of visual information to a user. The display 141 may include a display panel and/or a touch panel. The display 141 may include a cover glass.

The cover glass, together with the body 10, may form the exterior of the aerosol generating device 1. The cover glass may be in contact with a part of the body of the user. The cover glass may protect the display panel and/or the touch panel from an external impact.

The display panel may be disposed on the cover glass in a direction toward the inside of the body 10. The display panel may be disposed parallel to the cover glass.

The touch panel may detect a touch corresponding to contact with an object. For example, the touch panel may detect a touch corresponding to contact with a part of the body of the user. The touch panel may receive a user input.

A cover 104 may be placed on the upper side of the body 10. The cover 104 may have a shape corresponding to the shape of the opening 101 of the body 10. For example, the opening 101 of the body 10 may be circular, and the cover 104 may be circular with a diameter greater than the diameter of the opening 101.

The cover 104 may be movably connected to a guide 103 formed in the body 10. The cover 104 may move along the guide 103. For example, the guide 103 may be a groove formed in one surface of the body 10, and the cover 104 may include a protrusion that slides when inserted into the groove of the body 10. For example, the guide 103 may be a protrusion protruding from one surface of the body 10, and the cover 104 may have a groove inserted into the protrusion and slide along the protrusion.

The cover 104 may open and close the opening 101 of the body 10 by moving along the guide 103. For example, the cover 104 may close the opening 101 at a first position and open the opening 101 at a second position. The cover 104 may be manually moved by the user. Alternatively, the aerosol generating device 1 may have a driving device, and the cover 104 may be moved by the driving device.

The body 10 may include a connecting terminal (not shown). The connecting terminal may include a connector that allows the aerosol generating device 1 to be physically connected to an external electronic device. For example, the connecting terminal may include at least one of a high-definition multimedia interface (HDMI) connector, a universal serial bus (USB) connector, a secure digital (SD) card connector, or an audio connector (e.g., a headphones connector), or a combination thereof.

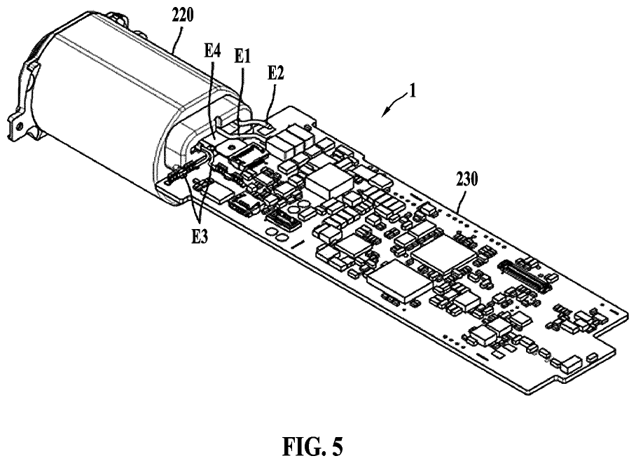

FIG. 5 is a rear perspective view of an internal structure of an aerosol generating device including a thermal insulator and a PCB, according to an embodiment of the present disclosure.

Referring to FIG. 5, the aerosol generating device 1 may include a thermal insulator 220. The thermal insulator 220 may be configured to thermally insulate the heater 240. The thermal insulator 220 may include the heater 240 inside the thermal insulator 220. The thermal insulator 220 may include an antenna (not shown) (e.g., an liquid-crystal display (LCD) antenna) inside the thermal insulator 220.

The thermal insulator 220 may be disposed to surround the heater 240, sealing the heater 240 to prevent the leakage of a droplet generated during an aerosol generating process through the heater 240. This may prevent a malfunction or damage to the components of the aerosol generating device 1 caused by the droplet.

The thermal insulator 220 may seal the heater 240 to prevent heat generated by the heater 240 from being transferred to the outer circumferential surface of the body 10. Thus, even when maintaining the heater 240 at a high temperature, it may be possible to prevent the transmission of high-temperature heat to the body (e.g., palm) of the user gripping the body 10.

The aerosol generating device 1 may include a PCB 230. For example, the PCB 230 may include at least one of the controller 12, the sensor 13, the memory 17, or a communication unit 16, or a combination thereof.

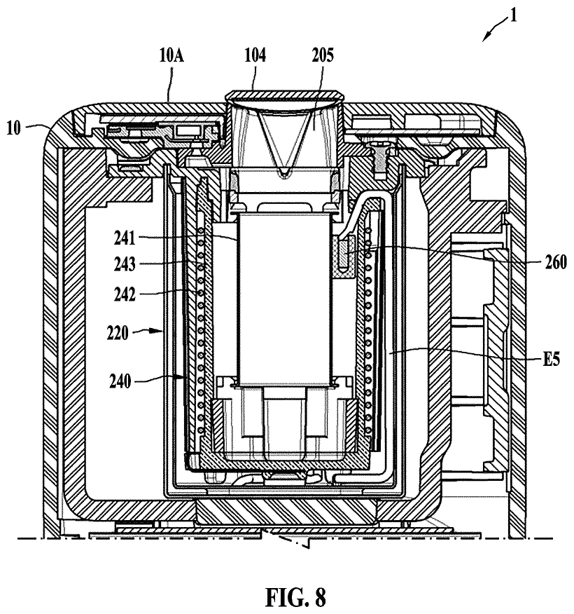

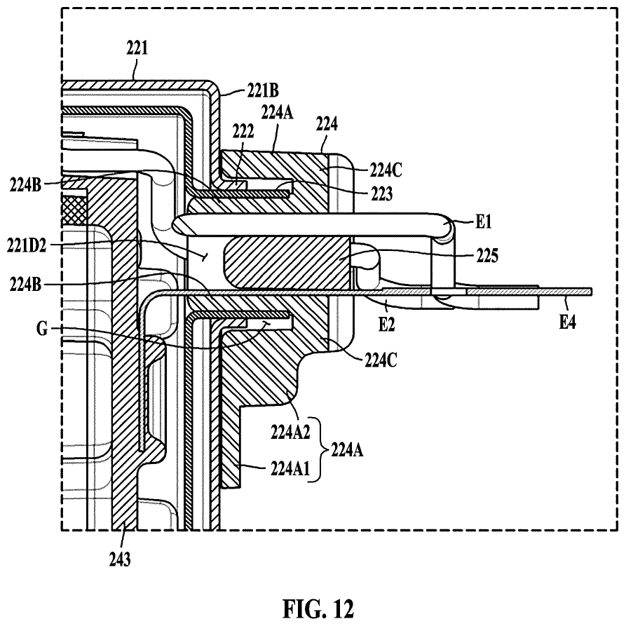

The aerosol generating device 1 may include a plurality of electrical lines (e.g., a first electrical line E1, a second electrical line E2, a third electrical line E3, and a fourth electrical line E4). For example, the first electrical line E1 may be configured to connect the heater 240 to a temperature sensor 260. The second electrical line E2 may be configured to connect a coil 242 (see FIG. 8) of the heater 240 to the PCB 230. At least one third electrical line E3 may be configured to connect at least one sensor (e.g., an insertion detection sensor 133 of FIG. 12) to the PCB 230. The fourth electrical line E4 may be configured to connect a heater housing 243 (see FIG. 8) of the heater 240 to the PCB 230. The fourth electrical line E4 may include a flexible printed circuit board (FPCB).

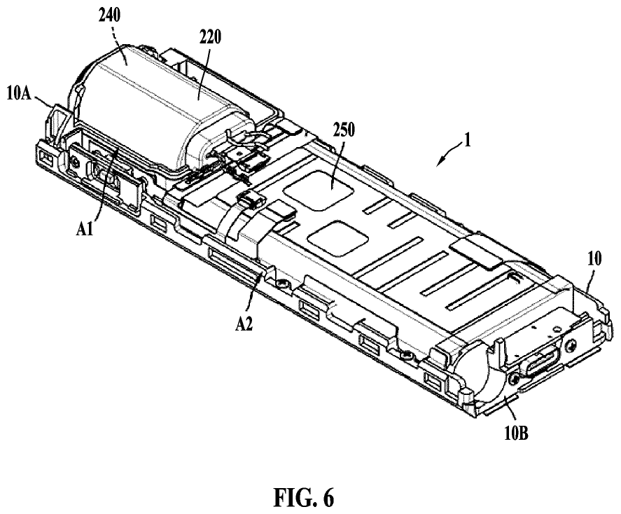

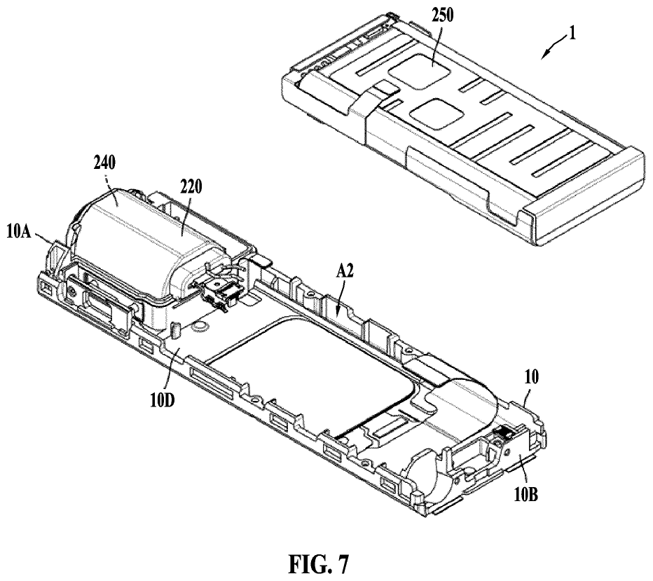

FIG. 6 is a rear perspective view of an internal structure of an aerosol generating device including a battery according to an embodiment of the present disclosure, and FIG. 7 is an exploded rear perspective view of the internal structure according to an embodiment of the present disclosure.

Referring to FIGS. 6 and 7, the body 10 of the aerosol generating device 1 may include a first portion A1. The first portion A1 may include a portion adjacent to the first body surface 10A of the body 10. The body 10 may include a second portion A2. The second portion A2 may be at least partially different from the first portion A1. The second portion A2 may include a portion adjacent to the second body surface 10B of the body.

The body 10 may include a wall A3. The wall A3 may separate the first portion A1 from the second portion A2. The wall A3 may extend from an inner surface 10D of the body 10 in a direction perpendicular to the inner surface 10D. The wall A3 may extend across the inner surface 10D in a direction (e.g., a width direction of the body 10) that intersects with a vertical direction (e.g., a thickness direction of the body 10) of the inner surface 10D. The direction may intersect with a direction (e.g., a longitudinal direction of the body 10) from the first body surface 10A to the second body surface 10B of the body 10.

A power source 250 may be disposed in the second portion A2 of the body 10. The power source 250 may include a pouch-type battery. The power source 250 may be adjacent to the PCB 230. For example, the power source 250 may be disposed on one side of the inner surface 10D of the body 10, and the PCB 230 may be disposed on the other side of the power source 250 opposite to the one side of the inner surface 10D. However, the placement of the PCB 230 and the power source 250 is not limited thereto.

The heater 240 may be disposed in the first portion A1 of the body 10.

The thermal insulator 220 may insulate the heater 240. The thermal insulator 220 may be disposed in the first portion A1 of the body 10. The thermal insulator 220 may surround the heater 240.

The aerosol generating device 1 may include a buffer structure (not shown). The buffer structure may be configured to buffer the power source 250. The buffer structure may be disposed on at least a portion of the inner surface 10D of the second portion A2 of the body 10. When an external impact is applied to the aerosol generating device 1, the buffer structure may reduce or prevent the impact applied to the power source 250.

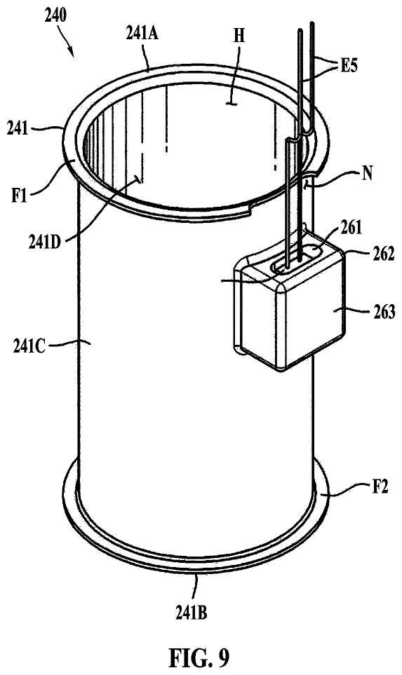

FIG. 8 is a cross-sectional view of an aerosol generating device according to an embodiment of the present disclosure, and FIG. 9 is a perspective view of an aerosol generating device including a susceptor and a temperature sensor, according to an embodiment of the present disclosure.

Referring to FIG. 8, the aerosol generating device 1 may include an article insertion portion 205. The article insertion portion 205 may guide the insertion of the stick S (see FIG. 3) into the heater 240. The article insertion portion 205 may be disposed on the first body surface 10A of the body 10.

The cover 104 may open and close the article insertion portion 205. The cover 104 may be configured to operate in a sliding or hinged manner.

The heater 240 may heat the stick S. The heater 240 may include the heater housing 243. The heater housing 243 may be disposed inside the body 10.

The heater 240 may include the coil 242. The coil 242 may be disposed on an outer side of the heater housing 243. The coil 242 may be wound around the heater housing 243. The coil 242 may surround at least a portion of an outer surface of the heater housing 243 and may be wound around the heater housing 243 in a spiral direction along the longitudinal direction of the heater housing 243. The coil 242 may have a first connecting portion (not shown) forming one end of the wound portion connected to at least one electrical line, and a second connecting portion (not shown) forming the other end of the wound portion connected to at least one other electrical line. The coil 242 may be connected to the PCB 230 through at least one electrical line.

The heater 240 may include a susceptor 241. The susceptor 241 may at least partially accommodate the stick S. The susceptor 241 may be configured to transfer heat to the stick S. For example, the susceptor 241 may be electrically coupled to the coil 242 and generate heat.

The aerosol generating device 1 may include the temperature sensor 260. The temperature sensor 260 may detect the temperature of the heater 240. The temperature sensor 260 may be disposed between the heater housing 243 and the susceptor 241. The temperature sensor 260 may be connected to the PCB 230 through an electrical line E5. The temperature sensor 260 may be connected to the controller 12 through the electrical line E5.

Referring to FIG. 9, the susceptor 241 may include a first surface 241A (e.g., a front surface), a second surface 241B (e.g., a rear surface) opposite to the first surface 241A, and a third surface 241C (e.g., a side surface) between the first surface 241A and the second surface 241B.

The first surface 241A may include a first opening H. The stick S may be inserted into the susceptor 241 through the first opening H. The first opening H may include a substantially circular or elliptical cross-section.

The second surface 241B may include a second opening (not shown). The second opening may allow the passage of an end of the stick S that is inserted into the susceptor 241. The second opening may include a substantially circular or elliptical cross-section.

The first surface 241A may include a first flange F1. The first flange F1 may expand from the third surface 241C in a width direction or radial direction. The first flange F1 may at least partially extend in a circumferential direction of the first surface 241A.

The first surface 241A may include a notch N. The notch N may be formed in one area of the first flange F1. At least one electrical line E5 may extend through at least a portion of the notch N.

The second surface 241B may include a second flange F2. The second flange F2 may expand from the third surface 241C in a width direction or radial direction. The second flange F2 may extend in a circumferential direction of the second surface 241B.

The susceptor 241 may include a body portion (e.g., 241A, 241B, and 241C) and a hollow portion 241D. The hollow portion 241D may be defined in the body portion (e.g., 241A, 241B, and 241C). The hollow portion 241D may extend between the first surface 241A and the second surface 241B. The hollow portion 241D may at least partially accommodate the stick S.

The heater 240 may include a pocket 262. The pocket 262 may include a pocket body 263. The pocket body 263 may be disposed on the third surface 241C of the susceptor 241. The pocket body 263 may be integrally and seamlessly connected to the third surface 241C.

The pocket 262 may include a recess (not shown). The recess may be disposed in the pocket body 263. The recess may accommodate the temperature sensor 260.

The pocket 262 may include a seal 261. The seal 261 may seal the temperature sensor 260. The seal 261 may be applied onto the temperature sensor 260 and filled inside the recess. The seal 261 may fill a space between the temperature sensor 260 and the inside of the recess, thereby sealing the temperature sensor 260. The seal 261 may include an adhesive material. For example, the adhesive material may include a ceramic. The seal 261 may increase the bonding strength between the temperature sensor 260 and the recess.

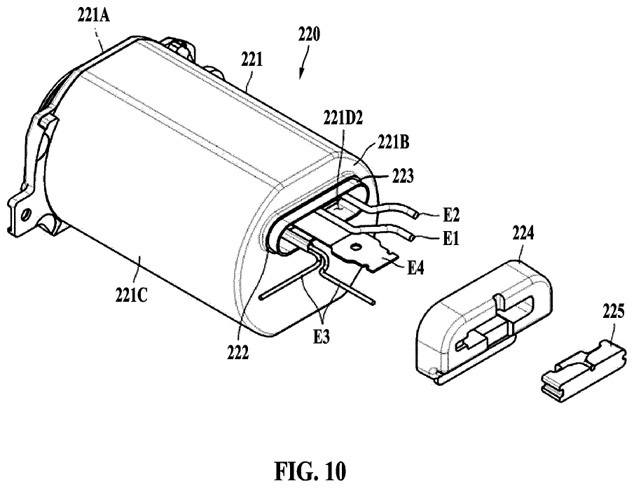

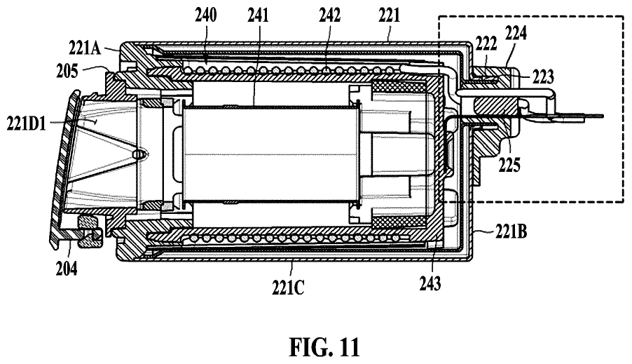

FIG. 10 is an exploded perspective view of a thermal insulator according to an embodiment of the present disclosure, FIG. 11 is a cross-sectional view of the thermal insulator according to an embodiment of the present disclosure, and FIG. 12 is a partially enlarged view of the thermal insulator of FIG. 11.

Referring to FIGS. 10 and 11, the thermal insulator 220 may include a thermally insulating housing 221. The thermally insulating housing 221 may include a first surface 221A (e.g., a front surface), a second surface 221B (e.g., a rear surface) opposite to the first surface 221A, and a third surface 221C (e.g., a side surface) between the first surface 221A and the second surface 221B. The first surface 221A, the second surface 221B, and the third surface 221C may surround the heater 240.

The thermally insulating housing 221 may include a first passage 221D1. The first passage 221D1 may allow the stick S to be inserted into the thermally insulating housing 221. The first passage 221D1 may include a substantially circular or elliptical cross-section.

The article insertion portion 205 of the aerosol generating device 1 may be provided to the first passage 221D1. The article insertion portion 205 may have a size and a shape suitable for guiding the stick S into the susceptor 241 of the heater 240.

The cover 204 of the aerosol generating device 1 may be provided to the first passage 221D1. The cover 204 may open and close the first passage 221D1. The cover 204 may open and close the article insertion portion 205. The cover 204 may operate in a sliding or hinged manner.

The thermally insulating housing 221 may include a second passage 221D2. The second passage 221D2 may allow a plurality of electrical lines (e.g., E1, E2, E3, and E4) to pass therethrough. The second passage 221D2 may have an elongated shape. The second passage 221D2 may be disposed on the second surface 221B of the thermally insulating housing 221.

The thermal insulator 220 may include a first flange 222. The first flange 222 may protrude from the second surface 221B. For example, the first flange 222 may protrude in a direction from the first surface 221A toward the second surface 221B. The first flange 222 may be integrally and seamlessly connected to the thermally insulating housing 221. The first flange 222 may include the second passage 221D2 defined at least partially inside the first flange 222.

The thermal insulator 220 may include a second flange 223. The second flange 223 may surround the plurality of electrical lines (e.g., E1, E2, E3, and E4). The second flange 223 may be disposed on an inner side of the first flange 222. At least a portion of the second flange 223 may extend between the first surface 221A and the second surface 221B along an inner side surface of the thermally insulating housing 221. At least a portion of the second flange 223 may extend along an inner surface opposite to the second surface 221B of the thermally insulating housing 221. At least a portion of the second flange 223 may be disposed in the second passage 221D2.

The second flange 223 may extend beyond the first flange 222. The distance between an end portion of the second flange 223 and the second surface 221B may be greater than the distance between an end portion of the first flange 222 and the second surface 221B.

The thermal insulator 220 may include a first seal 224 (e.g., an outer seal). The first seal 224 may be disposed to surround the first flange 222. The first seal 224 may be disposed to surround at least a portion of the second flange 223.

Referring to FIG. 12, the first seal 224 may include an outer enclosure 224A. The outer enclosure 224A may surround an outer side of the first flange 222 and/or an outer side of the second flange 223. The outer enclosure 224A may be disposed on or above the second surface 221B.

The outer enclosure 224A may extend in a direction from the first surface 221A toward the second surface 221B. The outer enclosure 224A may extend beyond the end portion of the first flange 222 and/or the end portion of the second flange 223.

The outer enclosure 224A may include a first base 224A1. The first base 224A1 may be disposed on or above the second surface 221B. The first base 224A1 may extend or expand in a direction away from the outer side of the first flange 222 and/or the outer side of the second flange 223.

The outer enclosure 224A may include a second base 224A2. The second base 224A2 may be disposed on the first base 224A1. The second base 224A2 may extend or expand in a direction away from the outer side of the first flange 222 and/or the outer side of the second flange 223.

The width of the second base 224A2 may be greater than the width of the first base 224A1. The first base 224A1 and the second base 224A2 may form a stepped shape.

The first base 224A1 may be integrally and seamlessly connected to the second base 224A2.

The first seal 224 may include an inner enclosure 224B. The inner enclosure 224B may surround an inner side of the first flange 222 and/or an inner side of the second flange 223. The inner enclosure 224B may be in at least partial contact with the second flange 223. The inner enclosure 224B may be configured to at least partially be deformed by the second flange 223. The inner enclosure 224B may remain deformed. The inner enclosure 224B may be disposed at least partially in the second passage 221D2.

The inner enclosure 224B may extend in a direction from the first surface 221A toward the second surface 221B. The inner enclosure 224B may extend beyond the end portion of the first flange 222 and/or the end portion of the second flange 223. The extending length of the inner enclosure 224B may be greater than the extending length of the outer enclosure 224A.

The distance between an end surface of the inner enclosure 224B and the second surface 221B may be substantially the same as the distance between an end surface of the outer enclosure 224A and the second surface 221B.

The outer enclosure 224A and the inner enclosure 224B may form a gap G. The first flange 222 may be disposed in the gap G. At least a portion of the second flange 223 may be disposed in the gap G.

The first seal 224 may include a connecting enclosure 224C. The connecting enclosure 224C may be configured to connect the outer enclosure 224A to the inner enclosure 224B. The connecting enclosure 224C may surround the end portion of the first flange 222 and/or the end portion of the second flange 223. The connecting enclosure 224C may extend or expand in a direction intersecting with (e.g., orthogonal to) the extending direction of the outer enclosure 224A and/or the extending direction of the inner enclosure 224B.

The outer enclosure 224A, the inner enclosure 224B, and the connecting enclosure 224C may be integrally and seamlessly connected to one another.

The first seal 224 may include an elastic material. For example, the first seal 224 may include rubber.

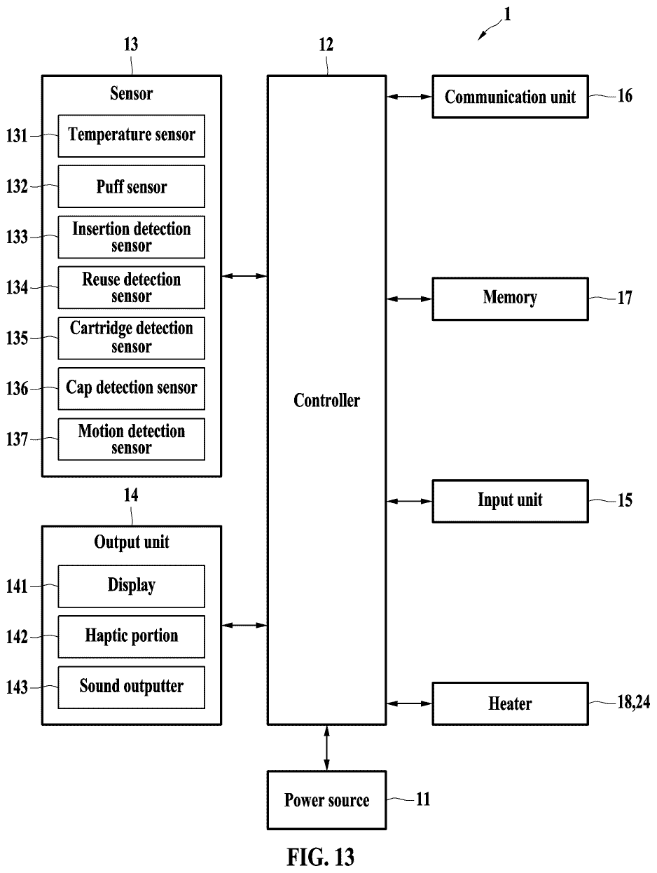

FIG. 13 is a block diagram of the aerosol generating device 1 according to an embodiment of the present disclosure.

The aerosol generating device 1 may include the power source 11, the controller 12, the sensor 13, an output unit 14, an input unit 15, the communication unit 16, the memory 17, and at least one heater 18, 24. However, an internal structure of the aerosol generating device 1 is not limited to what is shown in FIG. 13. It is to be understood by those having ordinary skill in the art to which the present disclosure pertains that some of the components shown in FIG. 13 may be omitted or new components may be added according to the design of the aerosol generating device 1.

The sensing unit 13 may sense a state of the aerosol generating device 1 or a state of an environment around the aerosol generating device 1, and transmit sensed information to the controller 12. Based on the sensed information, the controller 12 may control the aerosol generating device 1 to control operations of the cartridge heater 24 and/or the heater 18, restrict smoking, determine whether a stick S and/or a cartridge 19 is inserted, display a notification, and perform other functions.

The sensor 13 may include at least one of a temperature sensor 131, a puff sensor 132, an insertion detection sensor 133, a reuse detection sensor 134, a cartridge detection sensor 135, a cap detection sensor 136, and a motion detection sensor 137.

The temperature sensor 131 may sense a temperature at which the cartridge heater 24 and/or the heater 18 is heated. The aerosol generating device 1 may include a separate temperature sensor to sense the temperature of the cartridge heater 24 and/or the heater 18, or the cartridge heater 24 and/or the heater 18 itself may serve as a temperature sensor.

The temperature sensor 131 may output a signal corresponding to the temperature of the cartridge heater 24 and/or the heater 18. For example, the temperature sensor 131 may include a resistive element whose resistance value changes in response to a change in the temperature of the cartridge heater 24 and/or the heater 18. The temperature sensor 131 may be implemented by a thermistor, which is an element that uses the property that the resistance changes depending on the temperature. At this time, the temperature sensor 131 may output a signal corresponding to the resistance value of the resistive element as the signal corresponding to the temperature of the cartridge heater 24 and/or the heater 18. For example, the temperature sensor 131 may be configured as a sensor for detecting the resistance value of the cartridge heater 24 and/or the heater 18. At this time, the temperature sensor 131 may output a signal corresponding to the resistance value of the cartridge heater 24 and/or the heater 18 as the signal corresponding to the temperature of the cartridge heater 24 and/or the heater 18.

The temperature sensor 131 may be arranged around the power source 11 to monitor the temperature of the power source 11. The temperature sensor 131 may be disposed adjacent to the power source 11. For example, the temperature sensor 131 may be attached to one surface of a battery, which is the power source 11. For example, the temperature sensor 131 may be mounted on one surface of a PCB.

The temperature sensor 131 may be disposed inside the body 10 to sense the internal temperature of the body 10.

The puff sensor 132 may sense a puff from a user based on various physical changes in an airflow path. The puff sensor 132 may output a signal corresponding to the puff. For example, the puff sensor 132 may be a pressure sensor. The puff sensor 132 may output a signal corresponding to the internal pressure of the aerosol generating device 1. Here, the internal pressure of the aerosol generating device 1 may correspond to the pressure in an airflow path through which a gas flows. The puff sensor 132 may be disposed corresponding to the airflow path through which a gas flows in the aerosol generating device 1.

The insertion detection sensor 133 may sense the insertion and/or removal of the stick S. The insertion detection sensor 133 may sense a signal change according to the insertion and/or removal of the stick S. The insertion detection sensor 133 may be installed in the vicinity of an insertion space. The insertion detection sensor 133 may sense the insertion and/or removal of the stick S according to a change in the permittivity inside the insertion space. For example, the insertion detection sensor 133 may be an inductive sensor and/or a capacitance sensor.

The inductive sensor may include at least one coil. The coil of the inductive sensor may be disposed adjacent to the insertion space. For example, if the magnetic field changes around the coil through which an electric current flows, the properties of the current flowing through the coil may change according to Faraday's law of electromagnetic induction. Here, the properties of the current flowing through the coil may include the frequency of alternating current, the current value, the voltage value, the inductance value, the impedance value, and the like.

The inductive sensor may output a signal corresponding to the properties of the current flowing through the coil. For example, the inductive sensor may output a signal corresponding to the inductance value of the coil.

The capacitance sensor may include a conductor. The conductor of the capacitance sensor may be disposed adjacent to the insertion space. The capacitance sensor may output a signal corresponding to the electromagnetic properties of the surroundings, for example, the capacitance around the conductor. For example, when the stick S including a metal wrapper is inserted into the insertion space, the electromagnetic properties around the conductor may change due to the wrapper of the stick S.

The reuse detection sensor 134 may sense whether the stick S is reused. The reuse detection sensor 134 may be a color sensor. The color sensor may sense the color of the stick. The color sensor may sense the color of a portion of the wrapper that wraps around the outside of the stick S. The color sensor may detect a value of the optical properties corresponding to the color of an object based on light reflected from the object. For example, the optical properties may be the wavelength of light. The color sensor may be implemented as a single component in conjunction with a proximity sensor, or may be implemented as a separate component different from the proximity sensor.

At least a portion of the wrapper of the stick S may change in color due to an aerosol. The reuse detection sensor 134 may be disposed at a position corresponding to the position at which at least a portion of the wrapper that changes in color due to an aerosol is disposed when the stick S is inserted into the insertion space. For example, before the stick S is used by the user, the color of at least a portion of the wrapper may be a first color. At this time, as at least a portion of the wrapper is wet by the aerosol while the aerosol generated by the aerosol generating device 1 passes through the stick S, the color of the at least a portion of the wrapper may change to a second color. Meanwhile, the color of the at least a portion of the wrapper may be maintained as the second color after changing from the first color to the second color.

The cartridge detection sensor 135 may sense the mounting and/or removal of the cartridge 19. The cartridge detection sensor 135 may be implemented by an inductance-based sensor, a capacitive sensor, a resistance sensor, or a Hall sensor (e.g., Hall IC) using the Hall effect.

The cap detection sensor 136 may sense the mounting and/or removal of a cap. When the cap is detached from the body 10, a portion of the cartridge 19 and the body 10 covered by the cap may be exposed to the outside. The cap detection sensor 136 may be implemented by a contact sensor, a Hall sensor (e.g., Hall IC), an optical sensor, or the like.

The motion detection sensor 137 may sense a motion of the aerosol generating device 1. The motion detection sensor 137 may be implemented by at least one of an acceleration sensor and a gyro sensor.

In addition to the sensors 131 to 137 described above, the sensor 13 may further include at least one of a humidity sensor, a barometric pressure sensor, a magnetic sensor, a position sensor (e.g., global positioning system (GPS)), and a proximity sensor. A function of each of the sensors may be intuitively inferable from its name by one of ordinary skill in the art, and thus, a more detailed description thereof will be omitted here.

The output unit 14 may output information about the state of the aerosol generating device 1 and provide the information to the user. The output unit 14 may include at least one of a display 141, a haptic portion 142, or a sound outputter 143, but is not limited thereto. When the display 141 and a touchpad are provided in a layered structure to form a touchscreen, the display 141 may be used as an input device in addition to an output device.

The display 141 may visually provide information about the aerosol generating device 1 to the user. The information about the aerosol generating device 1 may include, for example, a charging/discharging state of the power source 11 of the aerosol generating device 1, a preheating state of the heater 18, an insertion/removal state of the stick S and/or the cartridge 19, a mounting/removal state of the cap, or a limited usage state (e.g., an abnormal article detected) of the aerosol generating device 1, or the like, and the display 141 may externally output the information. For example, the display 141 may be in a form of a light-emitting diode (LED) device. The display 141 may be, for example, a liquid-crystal display panel (LCD), an organic light-emitting display panel (OLED), or the like.

The haptic portion 142 may provide the information about the aerosol generating device 1 to the user in a haptic way by converting an electrical signal into a mechanical stimulus or an electrical stimulus. For example, the haptic portion 142 may generate vibrations corresponding to the completion of initial preheating when initial power is supplied to the cartridge heater 24 and/or the heater 18 for a set time. The haptic portion 142 may include, for example, a vibration motor, a piezoelectric element, or an electrical stimulation device.

The sound outputter 143 may provide the information about the aerosol generating device 1 to the user in an auditory way. For example, the sound outputter 143 may convert an electrical signal into a sound signal and externally output the sound signal.

The power source 11 may supply power to be used to operate the aerosol generating device 1. The power source 11 may supply power to heat the cartridge heater 24 and/or the heater 18. In addition, the power source 11 may supply power required for operations of the other components (e.g., the sensor 13, the output unit 14, the input unit 15, the communication unit 16, and the memory 17) included in the aerosol generating device 1. The power source 11 may be a rechargeable battery or a disposable battery. The power source 11 may be, for example, a lithium polymer (LiPoly) battery, but is not limited thereto.

Although not shown in FIG. 13, the aerosol generating device 1 may further include a power protection circuit. The power protection circuit may be electrically connected to the power source 11 and may include a switching element.

The power protection circuit may cut off an electrical circuit for the power source 11 under a predetermined condition. For example, the power protection circuit may cut off the electrical circuit for the power source 11 when the voltage level of the power source 11 is greater than or equal to a first voltage corresponding to overcharging. For example, the power protection circuit may cut off the electrical circuit for the power source 11 when the voltage level of the power source 11 is less than a second voltage corresponding to overdischarging.

The heater 18 may receive power from the power source 11 to heat a medium or an aerosol generating material in the stick S. Although not shown in FIG. 13, the aerosol generating device 1 may further include a power conversion circuit (e.g., a direct current (DC)-to-DC (DC/DC) converter) that converts power of the power source 11 and supplies the power to the cartridge heater 24 and/or the heater 18. In addition, when the aerosol generating device 1 generates an aerosol in an induction heating manner, the aerosol generating device 1 may further include a DC-to-alternating current (AC) (DC/AC) converter that converts DC power of the power source 11 into AC power.

The controller 12, the sensor 13, the output unit 14, the input unit 15, the communication unit 16, and the memory 17 may receive power from the power source 11 to perform functions. Although not shown in FIG. 13, a power conversion circuit, for example, a low dropout (LDO) circuit or a voltage regulator circuit, which converts power of the power source 11 and supplies the power to respective components, may further be included. In addition, although not shown in FIG. 13, a noise filter may be provided between the power source 11 and the heater 18. The noise filter may be a low-pass filter. The low-pass filter may include at least one inductor and at least one capacitor. The cutoff frequency of the low-pass filter may correspond to the frequency of a high-frequency switching current applied from the power source 11 to the heater 18. The low-pass filter may prevent the application of a high-frequency noise component to the sensor 13, such as the insertion detection sensor 133.

In an embodiment, the cartridge heater 24 and/or the heater 18 may be formed of a predetermined electrically resistive material that is suitable. The electrically resistive material may be a metal or a metal alloy including, for example, titanium, zirconium, tantalum, platinum, nickel, cobalt, chromium, hafnium, niobium, molybdenum, tungsten, tin, gallium, manganese, iron, copper, stainless steel, nichrome, or the like, but is not limited thereto. In addition, the heater 18 may be implemented as a metal heating wire, a metal heating plate on which an electrically conductive track is arranged, a ceramic heating element, or the like, but is not limited thereto.

In another embodiment, the heater 18 may be an induction heater. For example, the heater 18 may include a susceptor that heats the aerosol generating material by generating heat through a magnetic field applied by a coil.

The input unit 15 may receive information input from the user or may output information to the user. For example, the input unit 15 may be a touch panel. The touch panel may include at least one touch sensor for sensing a touch. For example, the touch sensor may include a capacitive touch sensor, a resistive touch sensor, a surface acoustic wave touch sensor, an infrared touch sensor, and the like, but is not limited thereto.

The display 141 and the touch panel may be implemented as a single panel. For example, the touch panel may be inserted into the display 141 (e.g., an on-cell type or in-cell type). For example, the touch panel may be added onto the display panel 141 (e.g., an add-on type).

Meanwhile, the input unit 15 may include a button, a keypad, a dome switch, a jog wheel, a jog switch, and the like, but is not limited thereto.

The memory 17, which is hardware for storing various pieces of data processed in the aerosol generating device 1, may store data processed by the controller 12 and data to be processed by the controller 12. The memory 17 may include at least one type of storage medium of flash memory-type memory, hard disk-type memory, multimedia card micro-type memory, card-type memory (e.g., secure digital (SD) or extreme digital (XD) memory), random access memory (RAM), static RAM (SRAM), read-only memory (ROM), electrically erasable programmable ROM (EEPROM), programmable ROM (PROM), magnetic memory, a magnetic disk, or an optical disk. The memory 17 may store an operating time of the aerosol generating device 1, a maximum number of puffs, a current number of puffs, at least one temperature profile, data associated with a smoking pattern of the user, or the like.

The communication unit 16 may include at least one component for communicating with another electronic device. For example, the communication unit 16 may include at least one of a short-range wireless communication unit and a wireless communication unit.

The short-range wireless communication unit may include a Bluetooth communication unit, a Bluetooth low energy (BLE) communication unit, a near-field communication unit, a wireless local area network (WLAN) (wireless fidelity (Wi-Fi)) communication unit, a ZigBee communication unit, an infrared data association (IrDA) communication unit, a Wi-Fi direct (WFD) communication unit, an ultra-wideband (UWB) communication unit, an Ant+ communication unit, and the like but is not limited thereto.

The wireless communication unit may include, for example, a cellular network communication unit, an Internet communication unit, a computer network (e.g., a LAN or a wide-area network (WAN)) communication unit, and the like but is not limited thereto.

Although not shown in FIG. 13, the aerosol generating device 1 may further include a connection interface such as a universal serial bus (USB) interface and may be connected to another external device through the connection interface such as a USB interface to transmit and receive information or to charge the power source 11.

The controller 12 may control the overall operation of the aerosol generating device 1. In an embodiment, the controller 12 may include at least one processor. The processor may be implemented as an array of a plurality of logic gates, or may be implemented as a combination of a general-purpose microprocessor and a memory in which a program executable by the microprocessor is stored. In addition, it is to be understood by one of ordinary skill in the art to which the disclosure pertains that it may be implemented in other types of hardware.

The controller 12 may control the temperature of the heater 18 by controlling the supply of power from the power source 11 to the heater 18. The controller 12 may control the temperature of the cartridge heater 24 and/or the heater 18 based on the temperature of the cartridge heater 24 and/or the heater 18 sensed by the temperature sensor 131. The controller 12 may adjust the power supplied to the cartridge heater 24 and/or the heater 18 based on the temperature of the cartridge heater 24 and/or the heater 18. For example, the controller 12 may determine a target temperature for the cartridge heater 24 and/or the heater 18 based on a temperature profile stored in the memory 17.

The aerosol generating device 1 may include a power supply circuit (not shown) electrically connected to the power source 11 between the power source 11 and the cartridge heater 24 and/or the heater 18. The power supply circuit may be electrically connected to the cartridge heater 24, the heater 18, or the induction coil 181. The power supply circuit may contain at least one switching element. The switching element may be implemented by a bipolar junction transistor (BJT), a field effective transistor (FET), or the like. The controller 12 may control the power supply circuit.

The controller 12 may control the power supply by controlling the switching of the switching element of the power supply circuit. The power supply circuit may be an inverter for converting DC power output from the power source 11 into AC power. For example, the inverter may be configured as a half-bridge circuit or a full-bridge circuit including a plurality of switching elements.

The controller 12 may turn on the switching element to supply power from the power source 11 to the cartridge heater 24 and/or the heater 18. The controller 12 may turn off the switching element to cut off the supply of power to the cartridge heater 24 and/or the heater 18. The controller 12 may adjust the current supplied from the power source 11 by adjusting the frequency and/or duty ratio of the current pulse input to the switching element.

The controller 12 may control the voltage output from the power source 11 by controlling the switching of the switching element of the power supply circuit. A power conversion circuit may convert the voltage output from the power source 11. For example, the power conversion circuit may include a buck-converter for decreasing the voltage output from the power source 11. For example, the power conversion circuit may be implemented through a buck-boost converter, a Zener diode, or the like.

The controller 12 may adjust the level of voltage output from the power conversion circuit by controlling an ON/OFF operation of the switching element included in the power conversion circuit. During the ON state of the switching element, the level of voltage output from the power conversion circuit may correspond to the level of voltage output from the power source 11. The duty ratio for the ON/OFF operation of the switching element may correspond to the ratio of the voltage output from the power conversion circuit to the voltage output from the power source 11. As the duty ratio for the ON/OFF operation of the switching element decreases, the level of voltage output from the power conversion circuit may decrease. The heater 18 may be heated based on the voltage output from the power conversion circuit.

The controller 12 may control to supply power to the heater 18 using at least one of a pulse width modulation (PWM) scheme and a proportional-integral-differential (PID) scheme.

For example, the controller 12 may control to supply a current pulse with a predetermined frequency and a duty ratio to the heater 18, using the PWM scheme. The controller 12 may control the power supplied to the heater 18 by adjusting the frequency and duty ratio of the current pulse.

For example, the controller 12 may determine a target temperature, the target of the controlling, based on the temperature profile. The controller 12 may control the power supplied to the heater 18 using the PID scheme, which is a feedback control scheme through the difference value between the temperature of the heater 18 and the target temperature, the value obtained by integrating the difference value over time, and the value obtained by differentiating the difference value over time.

The controller 12 may prevent overheating of the cartridge heater 24 and/or the heater 18. For example, the controller 12 may control the operation of the power conversion circuit to stop supplying power to the cartridge heater 24 and/or the heater 18 based on the temperature of the cartridge heater 24 and/or the heater 18 exceeding a preset temperature limit. For example, the controller 12 may reduce the amount of power supplied to the cartridge heater 24 and/or the heater 18 by a predetermined proportion, based on the temperature of the cartridge heater 24 and/or the heater 18 exceeding the preset temperature limit. For example, the controller 12 may determine that the aerosol generating material accommodated in the cartridge 19 is exhausted based on the temperature of the cartridge heater 24 exceeding the temperature limit, and cut off the power supply to the cartridge heater 24.

The controller 12 may control the charging and discharging of the power source 11. The controller 12 may verify the temperature of the power source 11 based on an output signal from the temperature sensor 131.

When a power line is connected to a battery terminal of the aerosol generating device 1, the controller 12 may verify whether the temperature of the power source 11 is greater than or equal to a first temperature limit which is the criterion for cutting off the charging of the power source 11. The controller 12 may control the power source 11 to be charged based on a preset charging current when the temperature of the power source 11 is less than the first temperature limit. The controller 12 may cut off the charging of the power source 11 when the temperature of the power source 11 is greater than or equal to the first temperature limit.

In a state in which the aerosol generating device 1 is powered on, the controller 12 may verify whether the temperature of the power source 11 is greater than or equal to a second temperature limit which is the criterion for cutting off the discharging of the power source 11. The controller 12 may control the power stored in the power source 11 to be used when the temperature of the power source 11 is less than the second temperature limit. The controller 12 may stop using the power stored in the power source 11 when the temperature of the power source 11 is greater than or equal to the second temperature limit.

The controller 12 may calculate the remaining capacity for the power stored in the power source 11. For example, the controller 12 may calculate the remaining capacity of the power source 11 based on the voltage of the power source 11 and/or the value of current sensed.

The controller 12 may determine whether the stick S is inserted into the insertion space through the insertion detection sensor 133. The controller 12 may determine that the stick S is inserted based on an output signal from the insertion detection sensor 133. When it is determined that the stick S is inserted into the insertion space, the controller 12 may control to supply power to the cartridge heater 24 and/or the heater 18. For example, the controller 12 may supply power to the cartridge heater 24 and/or the heater 18 based on the temperature profile stored in the memory 17.

The controller 12 may determine whether the stick S is removed from the insertion space. For example, the controller 12 may determine whether the stick S is removed from the insertion space through the insertion detection sensor 133. For example, the controller 12 may determine that the stick S is removed from the insertion space when the temperature of the heater 18 is greater than or equal to a temperature limit or when the gradient of the temperature change of the heater 18 is greater than or equal to a set gradient. When it is determined that the stick S is removed from the insertion space, the controller 12 may cut off the supply of power to the cartridge heater 24 and/or the heater 18.

The controller 12 may control the time of power supply and/or the amount of power supply to the heater 18 depending on the state of the stick S sensed by the sensor 13. The controller 12 may verify a level range including the level of a signal of the capacitance sensor based on a lookup table. The controller 12 may determine the amount of moisture in the stick S according to the verified level range.

When the stick S is in an over-humidified state, the controller 12 may increase the preheating time of the stick S compared to the case in which the stick S is in a normal state, by controlling the time of power supply to the heater 18.

The controller 12 may determine whether the stick S inserted into the insertion space is reused through the reuse detection sensor 134. For example, the controller 12 may compare a sensed value of a signal of the reuse detection sensor 134 with a first reference range including a first color, and when the sensed value falls within the first reference range, determine that the stick S is unused. For example, the controller 12 may compare the sensed value of the signal of the reuse detection sensor 134 with a second reference range including a second color, and when the sensed value falls within the second reference range, determine that the stick S is used. When it is determined that the stick S is used, the controller 12 may cut off the supply of power to the cartridge heater 24 and/or the heater 18.

The controller 12 may determine whether the cartridge 19 is coupled and/or decoupled, through the cartridge detection sensor 135. For example, the controller 12 may determine whether the cartridge 19 is coupled and/or decoupled based on a sensed value of a signal of the cartridge detection sensor 135.

The controller 12 may determine whether the aerosol generating material in the cartridge 19 is exhausted. For example, the controller 12 may preheat the cartridge heater 24 and/or the heater 18 by applying power, determine whether the temperature of the cartridge heater 24 exceeds the temperature limit in a preheating period, and determine that the aerosol generating material in the cartridge 19 is exhausted when the temperature of the cartridge heater 24 exceeds the temperature limit. When it is determined that the aerosol generating material in the cartridge 19 is exhausted, the controller 12 may cut off the supply of power to the cartridge heater 24 and/or the heater 18.

The controller 12 may determine whether the cartridge 19 is usable. For example, the controller 12 may determine that the cartridge 19 is unusable when the current number of puffs is greater than or equal to the maximum number of puffs set in the cartridge 19 based on the data stored in the memory 17. For example, the controller 12 may determine that the cartridge 19 is unusable when the total time for which the cartridge heater 24 is heated is greater than or equal to a preset maximum time or when the total amount of power supplied to the cartridge heater 24 is greater than or equal to a preset maximum amount of power.

The controller 12 may perform a determination about the inhalation of the user through the puff sensor 132. For example, the controller 12 may determine whether a puff occurs based on a sensed value of a signal of the puff sensor 132. For example, the controller 12 may determine the strength of the puff based on the sensed value of the signal of the puff sensor 132. When the number of puffs reaches the preset maximum number of puffs or when a puff is not detected for more than a preset time, the controller 12 may cut off the supply of power to the cartridge heater 24 and/or the heater 18.

The controller 12 may determine whether the cap is put on and/or taken off, through the cap detection sensor 136. For example, the controller 12 may determine whether the cap is put on and/or taken off based on a sensed value of a signal of the cap detection sensor 136.

The controller 12 may control the output unit 14 based on a result of sensing by the sensor 13. For example, when the number of puffs counted through the puff sensor 132 reaches a preset number, the controller 12 may inform the user that the aerosol generating device 1 is to be ended soon, through at least one of the display 141, the haptic portion 142, or the sound outputter 143. For example, the controller 12 may inform the user through the output unit 14 based on the determination that the stick S is absent from the insertion space. For example, the controller 12 may inform the user through the output unit 14 based on the determination that the cartridge 19 and/or the cap is not mounted. For example, the controller 12 may provide information on the temperature of the cartridge heater 24 and/or the heater 18 to the user through the output unit 14.

Based on the occurrence of a predetermined event, the controller 12 may store and update the history of the event that occurred in the memory 17. The event may include the detection of inserting the stick S, the initiation of heating the stick S, the detection of puffs, the end of puffs, the detection of overheating of the cartridge heater 24 and/or the heater 18, the detection of applying overvoltage to the cartridge heater 24 and/or the heater 18, the end of heating the stick S, the operation of powering ON/OFF the aerosol generating device 1, initiation of charging the power source 11, the detection of overcharging of the power source 11, the end of charging the power source 11, or the like, performed by the aerosol generating device 1. The history of the event may include the date and time the event occurred, log data corresponding to the event, and the like. For example, when the predetermined event is the detection of inserting the stick S, the log data corresponding to the event may include data on the sensed value of the insertion detection sensor 133. For example, when the predetermined event is the detection of overheating of the cartridge heater 24 and/or the heater 18, the log data corresponding to the event may include data on the temperature of the cartridge heater 24 and/or the heater 18, the voltage applied to the cartridge heater 24 and/or the heater 18, the current flowing in the cartridge heater 24 and/or the heater 18, and the like.

The controller 12 may control to form a communication link with an external device, such as a mobile terminal of the user. When authentication data is received from the external device via the communication link, the controller 12 may remove restrictions on the use of at least one function of the aerosol generating device 1. Here, the authentication data may include data indicating the completion of user authentication for the user corresponding to the external device. The user may perform user authentication through the external device. The external device may determine whether user data is valid based on the date of birth of the user, a unique number that identifies the user, and the like and receive data on the authority to use the aerosol generating device 1 from an external server. The external device may transmit data indicating the completion of user authentication to the aerosol generating device 1 based on the data on the authority to use. In response to the completion of the user authentication, the controller 12 may remove restrictions on the use of at least one function of the aerosol generating device 1. For example, in response to the completion of the user authentication, the controller 12 may remove restrictions on the use of a heating function that supplies power to the heater 18.

The controller 12 may transmit state data of the aerosol generating device 1 to the external device via the communication link with the external device. Based on the received state data, the external device may output the remaining capacity, the operation mode, and the like of the power source 11 of the aerosol generating device 1 through a display of the external device.

The external device may transmit a location search request to the aerosol generating device 1 based on an input that initiates a search for the location of the aerosol generating device 1. When the location search request is received from the external device, the controller 12 may control at least one of output devices to perform an operation corresponding to the location search based on the received location search request. For example, in response to the location search request, the haptic portion 142 may generate vibrations. For example, in response to the location search request, the display 141 may output an object corresponding to the location search and the end of the search.

When firmware data is received from the external device, the controller 12 may control to perform a firmware update. The external device may check the current version of the firmware for the aerosol generating device 1 and determine whether a new version of the firmware is present. When an input that requests a firmware download is received, the external device may receive a new version of firmware data and transmit the new version of firmware data to the aerosol generating device 1. When the new version of firmware data is received, the controller 12 may control to update the firmware of the aerosol generating device 1.

The controller 12 may transmit data on the sensed value of at least one sensor 13 through the communication unit 16 to an external server (not shown), receive a learning model generated by learning the sensed value through machine learning such as deep learning from the external server, and store the learning model. The controller 12 may perform an operation of determining an inhalation pattern of the user, an operation of generating a temperature profile, and the like using the learning model received from the external server. The controller 12 may store, in the memory 17, the sensed value data of at least one sensor 13 and the data used to train an artificial neural network (ANN). For example, the memory 17 may store a database for each component provided in the aerosol generating device 1, weights that form the structure of the ANN, and biases, for training the ANN. The controller 12 may generate at least one learning model that learns the data on the sensed value of at least one sensor 13, the inhalation pattern of the user, the temperature profile, and the like, stored in the memory 17, and is used to determine the inhalation pattern of the user and generate the temperature profile.

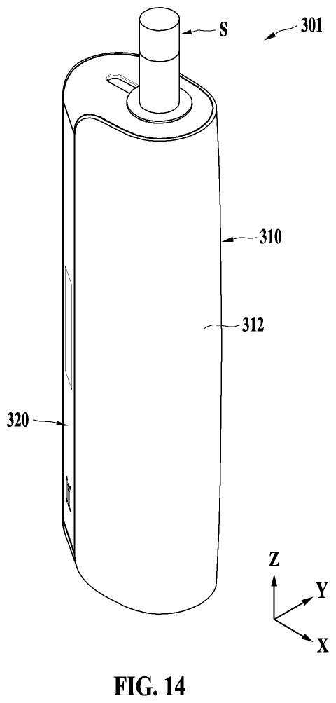

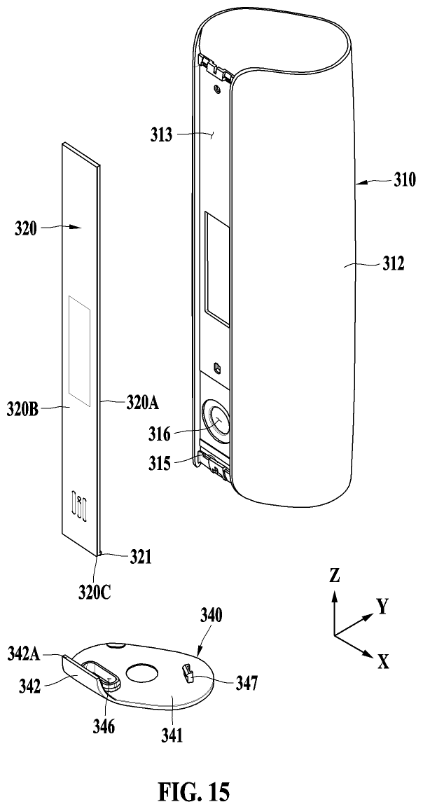

FIG. 14 is a perspective view of an aerosol generating device according to an embodiment. FIG. 15 is an exploded perspective view of an aerosol generating device showing a casing, a display window, and a cover according to an embodiment.

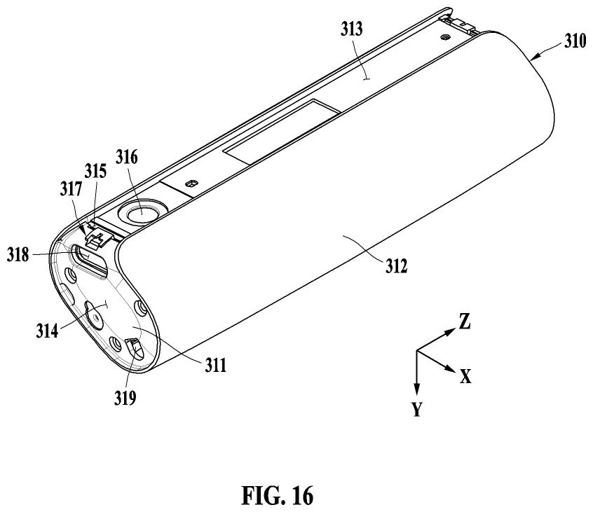

Referring to FIGS. 14 and 15, the aerosol generating device 301 may include a casing 310. The casing 310 may accommodate other components (e.g., the power source 11, the controller 12, the sensor 13, the heater 18, or the space for inserting the stick S of FIGS. 1, 2, or 4) therein. The casing 310 may include a side surface 312 extending in a first direction (e.g., +Z direction) from a base surface (e.g., a base surface 311 of FIG. 16).

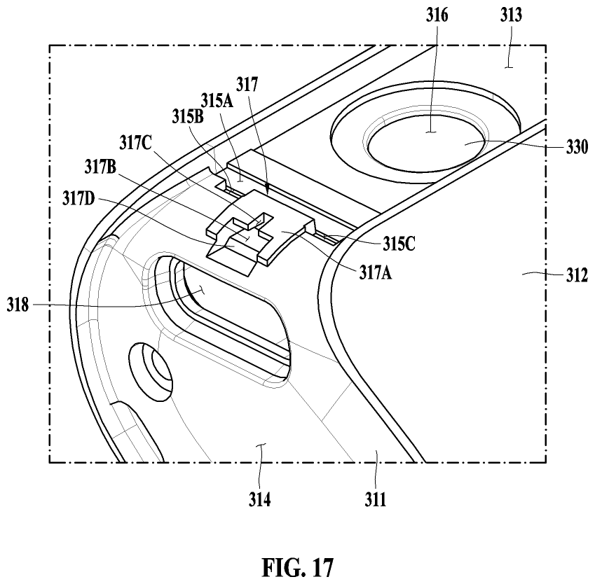

The side surface 312 may include a first recess 313 in which a display window 320 is disposed. The first recess 313 may be formed in a second direction (e.g., +Y direction) orthogonal to the first direction (e.g., +Z direction) from a portion of the side surface 312 facing a direction (e.g., −Y direction) that is opposite to the second direction. The display window 320 may fit into the first recess 313. A depth of the first recess 313 may be substantially equal to or greater than a thickness of the display window 320 in the second direction (e.g., +Y direction). The side surface 312 may include a button hole 316 disposed in the first recess 313. A button (e.g., a button 330 of FIG. 17) for operating the aerosol generating device 301 may be disposed in the button hole 316.

The casing 310 may include a first groove 315A. The first groove 315A may be positioned so that a rib (e.g., a first rib 321) is disposed therein. The first groove 315A may be formed on the side surface 312 having the first recess 313 in the second direction (e.g., +Y direction).

The aerosol generating device 301 may include the display window 320. The display window 320 may be disposed on the side surface 312 of the casing 310. The display window 320 may be disposed in the first recess 313. The user may operate the aerosol generating device 301 by pressing the display window 320. The display window 320 includes a display window inner surface 320A facing the casing 310, a display window outer surface 320B opposite to the display window inner surface 320A, and a display window end portion 320C in a direction (e.g., −Z direction) that is opposite to the first direction. The display window inner surface 320A and the display window outer surface 320B may have a rectangular shape, but are not limited thereto.

The display window 320 may include the first rib 321 protruding from the display window end portion 320C on the display window inner surface 320A in a direction opposite to the first direction. The first rib 321 may extend from the entire portion of the display window end portion 320C. For example, the first rib 321 may extend from the entire portion of the display window end portion 320C in a third direction (e.g., +X direction) that is substantially orthogonal to the first direction (e.g., +Z direction) and the second direction (e.g., +Y direction). Although not shown, a waterproofing member may be disposed on the display window inner surface 320A.

When the user presses the display window outer surface 320B, a portion (e.g., an end portion in the −Z direction) of the display window 320 may be moved in the second direction (e.g., +Y direction) toward the casing 310. When the portion of the display window 320 is moved in the second direction toward the casing 310, the display window 320 may press the button (e.g., the button 330 of FIG. 17). When the user does not press the display window 320, the display window outer surface 320B may be substantially coplanar with a portion of an outer surface of the side surface 312 (e.g., a portion adjacent to the display window outer surface 320B). For example, when the user presses the display window 320, a portion of the display window 320 moves toward the casing 310 and presses the button (e.g., the button 330 of FIG. 17). For example, when the user no longer presses the display window 320, the display window 320 may return to the position before being pressed, and no longer press the button (e.g., the button 330 of FIG. 17), and the display window outer surface and a portion of the side surface 312 may substantially form one surface. Through this structure, the aerosol generating device 301 may have a smooth button structure. The aerosol generating device 301 may have an exterior similar to that of not having a separate button.

The aerosol generating device 301 may include a cover 340 configured to be coupled to the casing 310. The cover 340 may include a first cover base 341 and a second cover base 342. The first cover base 341 may be coupled to the base surface of the casing 310 (e.g., the base surface 311 of FIGS. 16 and 17). The second cover base 342 may be connected to one side (e.g., −Y direction side) of the first cover base 341. The portion where the first cover base 341 and the second cover base 342 are connected may be partially curved. The second cover base 342 may be at least partially coupled to the side surface 312 of the casing 310. The cover 340 may include a charging hole 346 for connecting external power.

The charging hole 346 may be disposed in the first cover base 341. The cover 340 may include a connecting member 347 configured to be connected to the casing 310. The connecting member 347 may be disposed on the first cover base 341. Although not shown, the first cover base 341 and/or the casing 310 may include screw threads, and the cover 340 and the casing 310 may be coupled with screws.

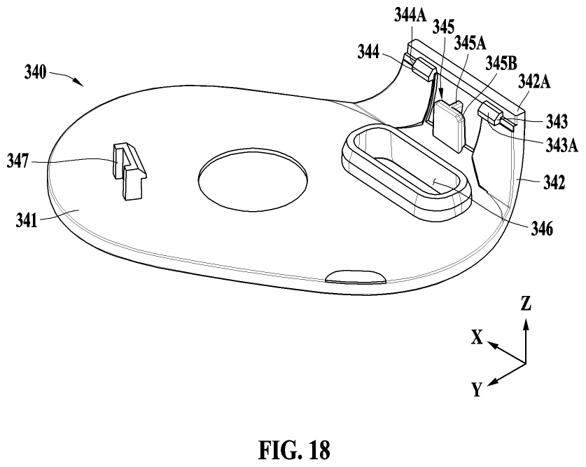

The cover 340 may include a flexible material. For example, the cover 340 may include plastic, but is not limited thereto. The cover 340 that is flexible and includes components to be coupled to the casing 310 may be coupled relatively easily to the casing 310. For example, in FIG. 18, the directions in which a second rib 343, a hook 345, and the connecting member 347 engage with the casing 310 are different from each other, however, all of the components may engage with the casing 310 since the cover 340 includes a flexible material.

FIG. 16 is a perspective view of a casing according to an embodiment. FIG. 17 is a perspective view of a casing and a button according to an embodiment.

Referring to FIGS. 16 and 17, the casing 310 may include the base surface 311. The base surface 311 may include a second recess 314 in which the first cover base 341 is disposed. The second recess 314 may be formed in a direction facing the first direction (e.g., +Z direction) from the base surface 311. A depth of the second recess 314 may be substantially equal to a thickness of the first cover base 341 in the first direction.

The casing 310 may include a second groove 315B in which a portion (e.g., the second rib 343 of FIGS. 18, 19, and 20) of the cover 340 may be disposed. The second groove 315B may be adjacent to the first groove 315A. A depth of the second groove 315B may be greater than a depth of the first groove 315A. In an embodiment not shown, the depth of the second groove 315B may be substantially equal to or less than the depth of the first groove 315A.

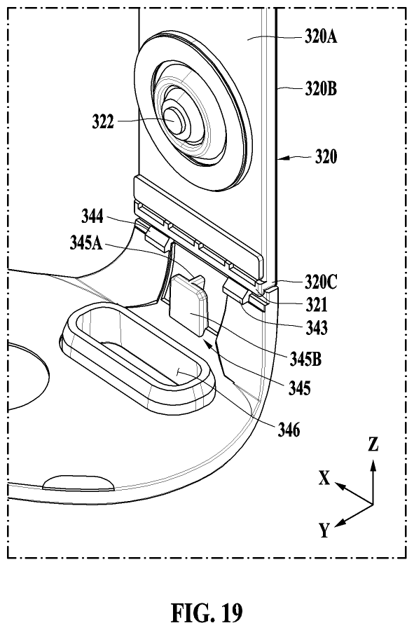

The casing 310 may include a third groove 315C in which a portion (e.g., a third rib 344 of FIGS. 18 and 19) of the cover 340 may be disposed. The third groove 315C may be adjacent to the first groove 315A. The third groove 315C may be spaced apart from the second groove 315B in the third direction (e.g., +X direction). A depth of the third groove 315C may be greater than the depth of the first groove 315A. The second groove 315B and the third groove 315C may be formed in the same shape. In an embodiment not shown, the depth of the third groove 315C may be substantially equal to or less than the depth of the first groove 315A.

The casing 310 may include a hook receiver 317 on which a portion (e.g., the hook 345 of FIGS. 18, 19, and 21) of the cover 340 may be disposed. The hook receiver 317 may be disposed in the first recess 313. The hook receiver 317 may be disposed in a portion of the first recess 313 and a portion of the second recess 314.

The hook receiver 317 may include a receiver base 317A that prevents or reduces movement of the cover 340 in a direction (e.g., −Y direction) opposite to the second direction. The hook receiver 317 may include a receiver opening 317B, into which a hook (e.g., the hook 345 of FIGS. 18, 19, and 21) may be inserted, on the receiver base 317A. A portion of the receiver base 317A and the side surface 312 may be spaced apart from each other with the receiver opening 317B interposed therebetween. The receiver base 317A may include a slit 317C into which a hook may be inserted. The slit 317C may be formed to extend from a direction (e.g., −Z direction) opposite to the first direction of the receiver base 317A to the first direction (e.g., +Z direction). The hook receiver 317 may include an inclined receiver surface 317D. The inclined receiver surface 317D may be formed so that the receiver opening 317B narrows in a direction in which the hook is inserted into the hook receiver 317. For example, the inclined receiver surface 317D may be a surface that is inclined to rise in a direction (e.g., −Y direction) opposite to the second direction toward the first direction (e.g., +Z direction).

When the cover 340 is coupled to the casing 310, the inclined receiver surface 317D may guide an insertion path of the hook. When the cover 340 is coupled to the casing 310, the hook may be inserted into the receiver opening 317B along the inclined receiver surface 317D. The hook receiver 317 may include a step connected to the inclined receiver surface 317D.

The base surface 311 may include a charging opening 318 that matches the charging hole 346. A size and a shape of the charging opening 318 may correspond to a size and a shape of the charging hole 346. The base surface 311 may include a connecting hole 319 for the connecting member 347.

The aerosol generating device 301 may include the button 330 for operating the aerosol generating device 301. The button 330 may include a dome switch or a tact switch, but is not limited thereto. The button 330 may be mounted on a PCB. The button 330 may be one of input units (e.g., the input unit 15 of FIG. 13). The button 330 may be disposed in the first recess 313. The button 330 may be disposed in the button hole 316. The user may press the button 330 by pressing the display window 320.

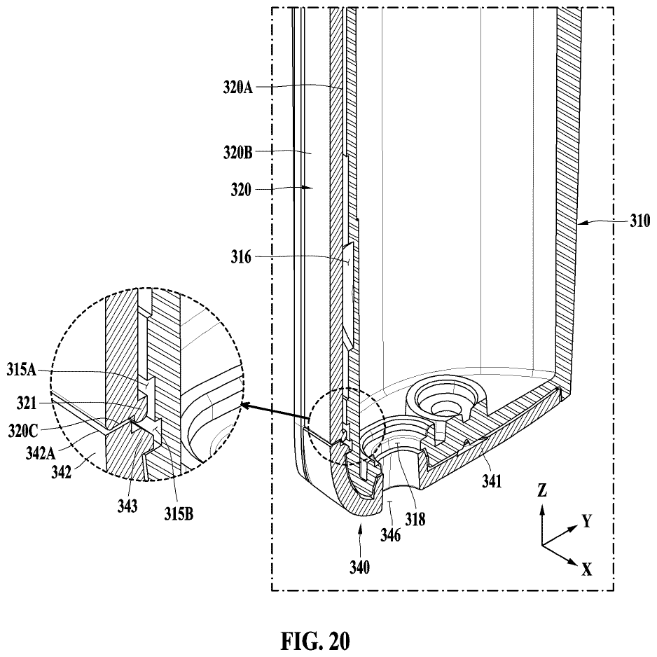

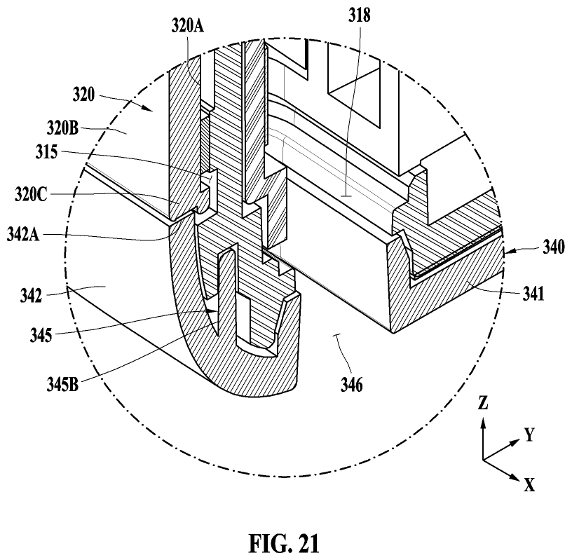

FIG. 18 is a perspective view of a cover according to an embodiment. FIG. 19 is a perspective view of a display window and a cover according to an embodiment. FIG. 20 is a cross-sectional view of an aerosol generating device according to an embodiment. FIG. 21 is a cross-sectional view of an aerosol generating device according to an embodiment.

Referring to FIGS. 18 to 21, the second cover base 342 of the cover 340 may include a second cover base end portion 342A adjacent to the display window 320. The second cover base end portion 342A may at least partially overlap the first rib 321. The second cover base end portion 342A may prevent or reduce the movement of the display window 320 in a direction (e.g., −Y direction) opposite to the second direction. For example, when the user has pressed the display window 320 and then no longer presses the display window 320, the display window 320 may move in a direction opposite to the second direction only until the first rib 321 touches the second cover base end portion 342A. The second cover base end portion 342A may cause the display window 320 to move to its original position. The second cover base end portion 342A may prevent or reduce the display window 320 from lifting.

The depth of the first groove 315A may be greater than a thickness of the first rib 321 in the second direction. The first rib 321 and the side surface 312 may be disposed with a gap in the first groove 315A. For example, when the user does not press the display window 320, the first rib 321 and the side surface 312 are disposed with a gap. Since the first rib 321 and the side surface 312 are disposed with a gap, the user may press the display window 320 to move the display window 320, thereby pressing the button 330. The display window 320 may include a switch 322 disposed on the display window inner surface 320A to press the button 330. When the user presses the display window 320, the switch 322 of the display window 320 may press the button 330. The switch 322 may cause the display window 320 to return to its original position when the user no longer presses the display window 320.

The cover 340 may include the second rib 343 that may be disposed in the second groove 315B. The second rib 343 may prevent or reduce the movement of the cover 340 in a direction (e.g., −Z direction) opposite to the first direction. The second rib 343 may prevent or reduce the cover 340 from being pushed. The second rib 343 may protrude in a direction (e.g., +Y direction) from the second cover base 342 toward the inside of the casing 310. The second rib 343 may include an inclined second rib surface 343A formed on an edge of the second rib 343. The second rib 343 may include a chamfered edge. The second rib 343 including the chamfered edge may be coupled relatively easily to the second groove 315B.

The cover 340 may include the third rib 344 that may be disposed in the third groove 315C. The third rib 344 may be spaced apart from the second rib 343. The third rib 344 may prevent or reduce the movement of the cover 340 in a direction (e.g., −Z direction) opposite to the first direction. The third rib 344 may prevent or reduce the cover 340 from being pushed. The third rib 344 may protrude in a direction (e.g., +Y direction) from the second cover base 342 toward the inside of the casing 310. The third rib 344 may include an inclined third rib surface 344A formed on an edge of the third rib 344. The third rib 344 may include a chamfered edge. The third rib 344 including the chamfered edge may be coupled relatively easily to the third groove 315C.

The cover 340 may include the hook 345 configured to engage with the hook receiver 317. The hook 345 may be disposed between the second rib 343 and the third rib 344. The hook 345 may prevent or reduce the movement of the cover 340 in a direction (e.g., −Y direction) opposite to the second direction. The hook 345 may include a first hook base 345A extending from the second cover base 342 in the second direction (e.g., +Y direction). The first hook base 345A may be disposed in the slit 317C. When the first hook base 345A is disposed in the slit 317C, the first hook base 345A may engage with the receiver base 317A.

The hook 345 may include a second hook base 345B that intersects the first hook base 345A and extends from an end portion of the first hook base 345A in the second direction, in the third direction (e.g., +X direction) and a direction (e.g., −X direction) opposite to the third direction. The second hook base 345B may be disposed in the receiver opening 317B. When the second hook base 345B is disposed in the receiver opening 317B, the second hook base 345B may engage with the receiver base 317A.

Some embodiments of the disclosure described above or other embodiments are not mutually exclusive or distinct from each other. Some embodiments of the disclosure described above or other embodiments may be used jointly or combined with each other in configuration or function.

For example, a configuration A described in one embodiment and/or drawing and a configuration B described in another embodiment and/or drawing may be combined with each other. Namely, although the combination between the configurations is not directly described, the combination is possible except in cases where it is described that the combination is impossible.

The above detailed description should not be construed in all aspects as limiting and should be considered illustrative. The scope of the present disclosure should be determined by rational interpretation of the appended claims, and all variations within the scope of equivalents of the present disclosure are included in the scope of the present disclosure.

What is claimed is:

1. An aerosol generating device comprising:
a casing comprising a base surface and a side surface connected to the base surface, wherein the side surface comprises a first recess;
a display window disposed in the first recess and comprising a first rib; and
a cover coupled to the casing and comprising a first cover base disposed on the base surface, a second cover base connected to one side of the first cover base and at least partially overlapping the first rib, and a second rib configured to engage with the casing.

2. The aerosol generating device of claim 1, further comprising:
a button disposed in the first recess and configured to be pressed when the display window is pressed.

3. The aerosol generating device of claim 2, wherein
the side surface further comprises a button hole disposed in the first recess, and
the button is disposed in the button hole.

4. The aerosol generating device of claim 1, wherein
while the display window is pressed, a portion of the window display close to the second cover base is configured to be moved in a direction from the display window toward the first recess, and
while the display window is not pressed, an outer surface of the display window is substantially coplanar with an outer surface of the second cover base.

5. The aerosol generating device of claim 1, wherein the casing further comprises a first groove where the first rib is disposed.

6. The aerosol generating device of claim 1, wherein
the cover further comprises a third rib spaced apart from the second rib, and
the second rib and the third rib protrude from the second cover base toward inside of the casing.

7. The aerosol generating device of claim 5, wherein the casing further comprises a second groove where the second rib is disposed.

8. The aerosol generating device of claim 7, wherein the second groove is connected to the first groove, and a depth of the second groove is greater than a depth of the first groove.

9. The aerosol generating device of claim 1, wherein
the display window further comprises a display window inner surface facing the side surface, a display window outer surface opposite to the display window inner surface, and a display window end portion close to the second cover base among end portions of the display window,
the first rib protrudes in a direction from the display window end portion toward the second cover base on the display window inner surface, and
the first rib extends from an entire portion of the display window end portion.

10. The aerosol generating device of claim 1, wherein
the cover further comprises a hook, and
the hook comprises a first hook base extending from the second cover base toward inside of the casing, and a second hook base extending from an end portion of the first hook base in a direction intersecting the extending direction of the first hook base.

11. The aerosol generating device of claim 10, wherein
the casing further comprises a hook receiver that engages with the hook, and
the hook receiver comprises a slit where the first hook base is disposed.

12. The aerosol generating device of claim 11, wherein the hook receiver further comprises a receiver opening where the second hook base is disposed.

13. The aerosol generating device of claim 11, wherein the hook receiver further comprises an inclined surface.

14. The aerosol generating device of claim 1, wherein the second rib comprises an inclined surface on an edge of the second rib.

15. The aerosol generating device of claim 1, wherein the base surface comprises a second recess where the first cover base is disposed.
